(19) United States
(12) Patent Application Publication
(10) Pub. No.: US 2025/0088859 A1
(43) Pub. Date: Mar. 13, 2025

(54) Low-Power and Privacy Key Resolution Using an Always on Processor

(71) Applicant: Apple Inc., CUPERTINO, CA (US)

(72) Inventors: Yann LY-GAGNON, San Francisco, CA (US); Andy WAGNER, Cupertino, CA (US); Anjali S SANDESARA, Sunnyvale, CA (US); Bryant LIU, San Jose, CA (US); Michelle J NG, San Francisco, CA (US); Yilok L WONG, San Diego, CA (US)

(21) Appl. No.: 18/825,267

(22) Filed: Sep. 5, 2024

Related U.S. Application Data
(60) Provisional application No. 63/581,454, filed on Sep. 8, 2023.

(51) Int. Cl. H04W 12/69; H04W 12/104

(52) U.S. Cl. CPC H04W 12/69; H04W 12/104

(57) ABSTRACT

An apparatus configured to process an indication of a wireless communication device with which the apparatus is allowed to perform find location operations, wherein the indication comprises a first identity resolving key (IRK) that is unique to the wireless communication device, process a payload of an advertisement comprising an IRK and compare the IRK to the first IRK received by the always on processor.

### PRIORITY/INCORPORATION BY REFERENCE

This application claims priority to U.S. Provisional Application Ser. No. 63/581,454 filed on Sep. 8, 2023, entitled “Low-Power and Privacy Key Resolution for People Finding Using an Always on Processor,” the entirety of which is incorporated by reference herein.

### BACKGROUND

There are various features that allow wireless devices to locate each other. However, these features are implemented when the wireless devices are online, e.g., actively connected to a wireless network. There may be situations where users of wireless devices desire to find each other in an offline environment, e.g., when one or both of the devices are not connected to a wireless network. There is currently no manner of locating another device in an offline environment.

### SUMMARY

Some example embodiments are related to an apparatus having processing circuitry configured to process an indication of a wireless communication device with which the apparatus is allowed to perform find location operations, wherein the indication comprises a first identity resolving key (IRK) that is unique to the wireless communication device, process a payload of an advertisement comprising an IRK and compare the IRK to the first IRK received by the always on processor.

Other example embodiments are related to a method for receiving an indication of a wireless communication device with which find location operations are allowed to be performed, wherein the indication comprises a first identity resolving key (IRK) that is unique to the wireless communication device, receiving a payload of an advertisement comprising an IRK and comparing the IRK to the first IRK.

Still further example embodiments are related to a first wireless communication device having a transceiver configured to communicate with a second wireless communication device and an always on processor configured to process an indication of the second wireless communication device allowed to perform find location operations with the first wireless communication device, wherein the indication comprises a first identity resolving key (IRK) that is unique to the second wireless communication device, process a payload of an advertisement comprising an IRK and compare the IRK to the first IRK received by the always on processor.

### BRIEF DESCRIPTION OF THE DRAWINGS

FIG. 1 shows an example arrangement according to various example embodiments.

FIG. 2 shows an example of a wireless communication device according to various example embodiments.

FIG. 3 shows an example call flow for forming a friendship relationship between a finder and a findee according to various example embodiments.

FIG. 4 shows an example call flow for performing a find location operation between a finder and a findee according to various example embodiments.

FIG. 5 shows an example method for performing a find location operation according to various example embodiments.

### DETAILED DESCRIPTION

The example embodiments may be further understood with reference to the following description and the related appended drawings, wherein like elements are provided with the same reference numerals. The example embodiments relate to locating a wireless communication device using low power communications.

The example embodiments are described with regard to wireless communication devices. As will be described in greater detail below, the wireless communication devices may include any electronic component configured with the hardware, software, and/or firmware to establish a short-range wireless connection to another wireless communication device.

Example embodiments include the use of short-range communication connections. In some examples, a short-range communication connection may be a Bluetooth connection, e.g., Bluetooth Classic, Bluetooth Low-Energy (BLE), etc. This is only an example and the principles described herein for the example embodiments may be applied to other types of short-range communication connections.

The example embodiments are also described with reference to a finder and a findee. In this context, the “findee” is the user that is sharing their location with others. The “finder” is the user that receives the location from another user.

The example embodiments allow a findee to share their location while continuing to protect the user's privacy. Specifically, the findee may not broadcast their location. Rather, the findee may form a friendship relationship with the finder that allows the finder to search for the findee without the findee broadcasting their location. The friendship relationship allows the finder and the findee to perform the finding operations using low power communications when one or both of the finder and findee are offline. The low power communications allow the finder and findee to discover each other and once the discovery occurs, the finder and findee may perform a ranging operation (e.g., an ultra-wideband (UWB) ranging operation) to determine a more accurate location of the findee. These example embodiments will be described in greater detail below.

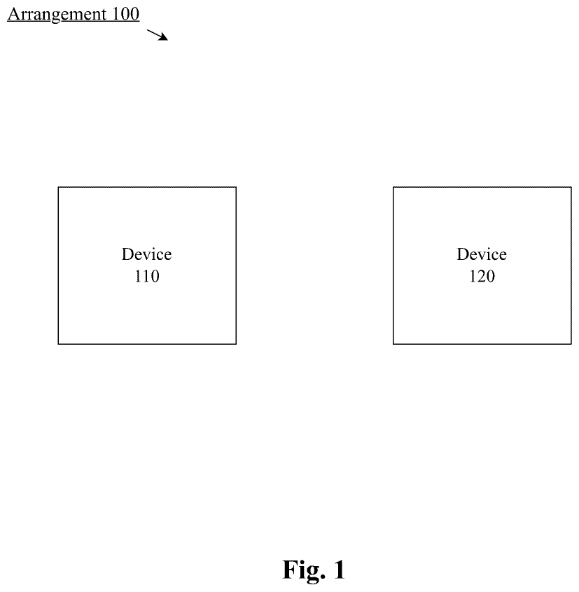

FIG. 1 shows an example arrangement 100 according to various example embodiments. The example arrangement 100 includes a first wireless communication device 110 and a second wireless communication device 120. Examples of these wireless communication devices 110 and 120 will be described in greater detail below. In the example of FIG. 1, the first wireless communication device 110 and the second wireless communication device 120 may not currently have a connection to each other.

In this example, the user of the first wireless communication device 110 may wish to locate the user of the second wireless communication device 120. As will be described in greater detail below, the users of the first and second wireless communication devices 110 and 120 may form a relationship that allows the first and second wireless communication devices 110 and 120 to find each other. In the example of the user of the first wireless communication device 110 wishing to locate the user of the second wireless communication device 120, the user of the second wireless communication device 120 may be considered to be the “findee,” e.g., the user that is sharing their location with others. The user of the first wireless communication device 110 may be considered to be the “finder,” e.g., the user that receives the location from another user.

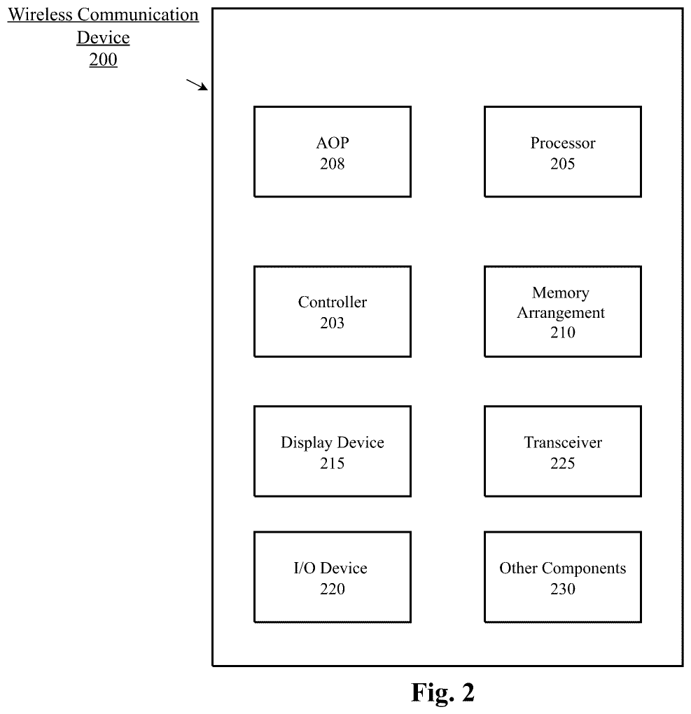

FIG. 2 shows an example wireless communication device 200 according to various example embodiments. The wireless communication device 200 of FIG. 2 may represent the wireless communication device 110 or 120 described with regard to FIG. 1. The wireless communication device 200 may be any type of electronic component that is configured to connect to another wireless communication device via a short-range communication connection. Non-limiting examples include mobile phones, smartphones, tablet computers, desktop computers, wearables, embedded devices, Internet of Things (IoT) devices, etc.

The wireless communication device 200 may include a processor 205, an always on processor (AOP) 208, a controller 203, a memory arrangement 210, a display device 215, an input/output (I/O) device 220, a transceiver 225, and other components 230. The other components 230 may include, for example, an audio input device, an audio output device, a data acquisition device, ports to electrically connect to other electronic devices, sensors to detect conditions of the device, etc.

The processor 205 may be configured to execute a plurality of engines for the wireless communication device 200. For example, the engines may perform operations related to locating another wireless communication device, including, but not limited to, forming a relationship with another wireless communication device, informing other components of the wireless communication device about the relationship, and forming responses to another wireless communication device attempting to find the wireless communication device. Examples of these operations will be described in greater detail below.

The above referenced engines being an application (e.g., a program) executed by the processor 205 is only an example. The functionality associated with the engines may also be represented as a separate incorporated component of the wireless communication device 200 or may be a modular component coupled to the wireless communication device 200, e.g., an integrated circuit with or without firmware. For example, the integrated circuit may include input circuitry to receive signals and processing circuitry to process the signals and other information. The engines may also be embodied as one application or separate applications. In addition, in some parent devices, the functionality described for the processor 205 is split among two or more processors such as a baseband processor and an applications processor. The example embodiments may be implemented in any of these or other configurations of a parent device.

The AOP 208 may be communicatively coupled to the processor 205. The AOP 208 may also be configured to execute one or more engines to perform operations related to locating another wireless communication device, including, but not limited to, determining if other wireless communication devices are allowed to find the wireless communication device based on an advertisement received from the other wireless communication devices and waking up an application processor when an allowed other wireless communication device wants to perform a find location process with the wireless communication device. Examples of these operations will be described in greater detail below.

The above referenced engines of the AOP 208 being an application (e.g., a program) executed by the AOP 208 is only an example. The functionality associated with the engines may also be represented as a separate incorporated component of the wireless communication device 200 or may be a modular component coupled to the wireless communication device 200, e.g., an integrated circuit with or without firmware.

The memory arrangement 210 may be a hardware component configured to store data related to operations performed by the wireless communication device 200. The display device 215 may be a hardware component configured to show data to a user, e.g., display user interfaces (UIs), text messages, etc. The I/O device 220 may be a hardware component that enables the user to enter inputs (e.g., to locate another person, to allow find location services to be used, etc.). The display device 215 and the I/O device 220 may be separate components or integrated together such as a touchscreen.

The transceiver 225 may be a hardware component configured to establish a wireless connection with one or more networks or with one or more other wireless communication devices. The transceiver may be configured for operating using more than one radio access technology. Accordingly, the transceiver 225 may operate on a variety of different frequencies or channels (e.g., set of consecutive frequencies) to communicate with the networks and/or other wireless communication devices. The transceiver may be configured for operating using a short-range communication protocol, e.g., Bluetooth. The transceiver 225 may include separate transceiver circuitry for each of a respective type of wireless connection, radio access technology, and/or range of frequencies of operation. The transceiver may comprise transceiver circuitry configured for operating using Bluetooth communication. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals for implementing any one of the methods described herein.

The controller 203 may be a hardware component configured to manage aspects of communicating over a wireless link. The controller 203 may be a Bluetooth controller. In some examples, the controller 203 may perform tasks for managing physical layer and link layer operations. Such operations may include, for example, frequency hopping, modulation, packet formatting, error correction, etc. The controller 203 may be operably coupled to the processor 205 (and may also be operably coupled to the AOP 208), and may assist in executing any one of the engines described herein.

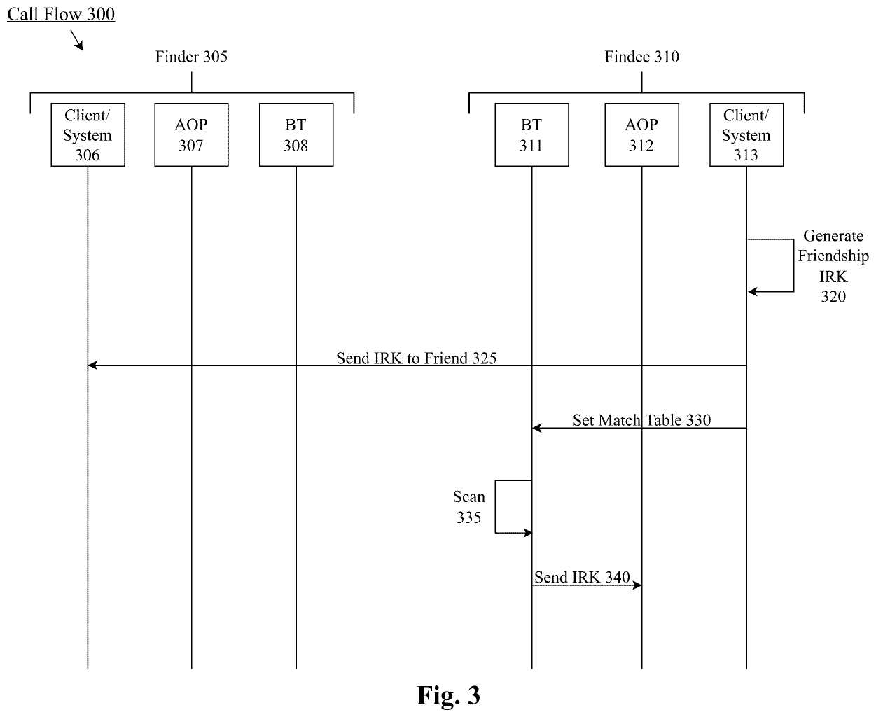

FIG. 3 shows a call flow 300 for forming a friendship relationship between a finder 305 and a findee 310 according to various example embodiments. The call flow 300 is described with reference to the arrangement 100 of FIG. 1 where the finder 305 may be the wireless communication device 120 and the findee 310 may be the wireless communication device 110. Some of the operations of the call flow 300 may be performed when the finder 305 and the findee 310 are online, e.g., connected to a wireless network. This will be noted in the below description of the call flow 300.

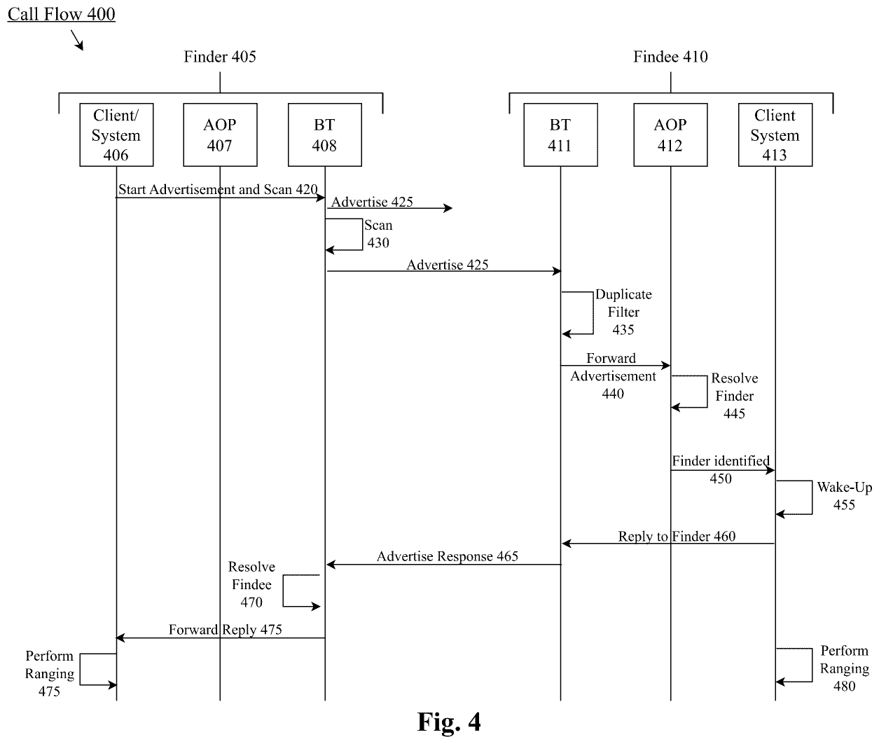

The finder 305 may include a client/system 306 (e.g., executed by the processor 205), an AOP 307 and a Bluetooth (BT) controller 308. Similarly, the findee 310 may include a client/system 313, an AOP 312 and a BT controller 311. Not all of these components perform operations in the call flow 300. However, the components are shown to maintain consistency with the further call flows described herein, e.g., the call flow 400 of FIG. 4).

In 320, the client/system 313 of the findee 310 generates a friendship identity resolving key (IRK). The friendship IRK may be a one-to-one key that relates the findee 310 to the finder 305, e.g., the friendship IRK generated in 320 is unique to the finder 305/findee 310 friendship and only the friendship pair will know this friendship IRK and no other device can resolve the finder 305 or findee 310 using the friendship IRK. While not shown in the call flow 300, the user sharing their location can revoke that permission at any time, either offline (e.g., by disabling a specific friendship IRK) or online (e.g., by indicating to the finder that the friendship IRK is no longer active).

Prior to the findee 310 generating the friendship IRK in 320, the finder 305 and the findee 310 (or the users thereof) may have communicated their intention to form a friendship relationship to initiate the generating of the friendship IRK. For example, the finder 305 and/or the findee 310 may have a find location application and the users may enter their intention to form a friendship via a user interface (UI) of the application.

In 325, the findee 310 may send the friendship IRK to the finder 305, e.g., the client/system 306 of the findee 305. As described above, some of the operations of the call flow 300 may be performed online. The operation 325 may be one of the operations that are performed online, e.g., the finder 305 and the findee 310 may have to be in communication for the finder 310 to receive the friendship IRK.

In 330, the client/system 313 of the findee 310 may update a match table to include the friendship IRK of the finder 305/findee 310. The BT controller may maintain a match table (e.g., a table in firmware that identifies all friendship IRKs of the findee 310). The use of this table will be described in greater detail below.

In 335, the BT controller 311 of the findee 310 may begin to scan for BT advertisements from other wireless communication devices that are attempting to find the findee 310. The scanning operation may be any scanning operation supported by the Bluetooth protocol being executed by the findee 310. The findee 310 may perform the scanning operations when the table in the BT firmware includes any entries, e.g., an indication that the findee 310 has at least one friendship that allows a finder to find the findee 310. In addition, the scanning operations may be performed when the findee 310 is offline, e.g., has no connection to a wireless network. In the example call flow 300, the scanning operation is shown as a discrete operation having an ending time. This is only for illustrative purposes. The scanning operation 335 may be continuous until the user of the findee 310 turns off this capability or until the findee 310 has identified a finder (e.g., finder 310) and begins to perform full power operations as will be described in greater detail below. In some examples, the findee will perform the scanning operations at a rate of 30 ms for every 966 ms interval or 50 ms for every 966 ms interval. These scanning rates are only an example and other scanning rates may be used.

In 340, the BT controller 311 may send one or more friendship IRKs that are in the BT firmware table to the AOP 312, including the friendship IRK for the finder 305/findee 310. Use of this information by the AOP 312 will be described in greater detail below.

FIG. 4 shows a call flow 400 for performing a find location operation between a finder 405 and a findee 410 according to various example embodiments. The finder 405 may include a client/system 406, an AOP 407 and a BT controller 408. The findee 410 may include a client/system 413, an AOP 412 and a BT controller 411. The finder 405 and the findee 410 may comprise components similar to those described with respect to FIG. 3. The call 400 may be considered to continue from the call flow 300, e.g., the findee 410 may be actively scanning (e.g., scanning operation 335 described with reference to FIG. 3) for wireless communication devices that are attempting to find the findee 410. In addition, as described above, at the start of the call flow 400, one or both of the finder 405 and findee 410 may be offline, e.g., no connection to a wireless network.

In 420, the client/system 406 of the finder 405 instructs the BT controller 408 to begin transmitting BT advertisements and performing scanning operations for the findee 410. For example, the user of the finder 405 may open a find location application using the client/system 406 and enter information on a UI indicating that the user of the finder 405 wishes to locate the findee 410.

Operation 420 may include the client/system 406 providing the BT controller 408 with information that is to be included in the payload of the advertisement. For example, the advertisement payload may include an authorization tag that is encrypted using the friendship IRK of the finder/findee, e.g., such that only the findee can decrypt the authorization tag. In one example, the encryption may be performed using a SipHash function on the BT address of the finder and the friendship IRK. This may be used to generate a 6 byte SipHash and the authorization tag may be the first 3 bytes of the SipHash. When this authorization tag is included in the payload of the BT advertisement, the other side (e.g., the findee) may resolve the payload because the other side can run a corresponding SipHash function based on also having the BT address and friendship IRK. Using this type of authorization tag may protect the privacy of the users because the BT address rotates approximately every 15 minutes and therefore the authorization tag will also change. Thus, this example authorization tag is neither static nor in plaintext. This payload of a BT advertisement payload is only an example and other payloads may be used.

In 425, the BT controller 408 of the finder 405 transmits BT advertisements including the payload related to finding the findee 410. In 430, the BT controller 408 performs scanning operations to determine if the findee 410 has responded to the BT advertisements. Again, in the call flow 400, the operations 425 and 430 are shown as discrete operations. However, these operations may be performed continuously until the findee 410 is located or the user of the finder 405 discontinues attempting to locate the findee 410. In some examples, the BT advertisements may be transmitted at a rate of 30 ms and the scanning operations may be performed at a rate of 30/40 ms. However, these rates are only an example and other rates may be used.

Continuing with the call flow 400, shown below the scanning operation 430, another BT advertisement 425 is shown. As stated above, the advertising operation may comprise sending one or more advertisements. The findee 410 may receive any of these one or more advertisements. In this example, it may be considered that the BT advertisement is received by the BT controller 411 of the findee 410, e.g., the BT scanning operation performed by the BT controller 411 detects the BT advertisement 425. However, the findee 410 may receive a prior BT advertisement or a subsequent BT advertisement rather than the BT advertisement shown as being received in FIG. 4. In 435, the BT controller 411 may pass the BT advertisement 425 through a duplicate filter, e.g., the BT controller 411 may only pass unique BT advertisements on to the AOP 412. In this example, it may be considered that the BT advertisement 425 passes the duplicate filter and, in 440, the BT controller 411 forwards the BT advertisement 425 to the AOP 412.

In 445, the AOP 412 resolves whether the finder 405 identified in the BT advertisement 425 has a friendship with the findee 410. As described above, the BT controller 411 may send the AOP 410 the entries of the other wireless communication devices with which the findee 410 has formed friendship IRKs (e.g., finders). The AOP 412 may decrypt the payload information from the BT advertisement 425, e.g., BT address and friendship IRK, and compare this to any friendship IRKs entries previously provided by the BT controller 411. If the decrypted payload information matches an entry, the AOP 412 may determine that the finder 405 is entitled to locate the findee 405. If there are no matching entries, the AOP 412 may ignore the BT advertisement 425.

Using the AOP 412 to resolve the friendship IRK, the findee 410 may better control privacy. As can be seen from the call flows 300 and 400, while the findee 410 has allowed other wireless communication devices to locate the findee 410 (or 310), the findee 410 is not broadcasting its location. Rather, the findee 410 is scanning for the other wireless communication devices (e.g., finders) that may be attempting to locate the findee 410. Thus, the example embodiments eliminate the need for a findee to broadcast its location, which could jeopardize the privacy of the findee (or user of a findee device).

In some example embodiments, when the findee 410 is offline, the application and/or baseband processor may be in a low power mode (e.g., standby mode, sleep mode, etc.). The example embodiments allow the application and/or baseband processor to remain in the low power mode during the locating process because the BT controller 411 and the AOP 412 may perform all the relevant operations until the AOP 412 resolves a finder 405 with which the findee 410 has formed a friendship.

In 450, when the AOP 412 has identified the finder 405 having a friendship IRK with the findee, the AOP 412 may inform the client/system 413 of the findee. This may trigger, in 455, the client/system 413 to wake up from a low power mode. In 460, the client/system 413 may instruct the BT controller 411 to respond to the BT advertisement 425 by transmitting a BT advertisement as shown in 465. The BT advertisement 465 may include the friendship IRK that may be used by the finder 405 as described below. In one example, the BT advertisement 425 may have an advertisement rate of 30 ms but other advertising rates may be used.

As described above, when the finder 405 begins the find location operation, the finder starts scanning operations 430 to determine if the findee 410 has responded to the BT advertisements 425. Thus, it may be considered in this example, that the finder 405 has received the BT advertisement 465 that was transmitted in response to the BT advertisement 425.

In 470, the BT controller 408 may compare the information in the BT advertisement 465 to a match table included in the BT firmware of the finder 405, e.g., the finder 405 may have a table similar to a table of the findee 410 firmware table that includes the friendship IRKs formed by the finder 405. The BT controller 408 may perform this operation to ensure that the BT advertisement 465 was intended as a response to the BT advertisement 425 before passing the information to the client/system 406.

Once the finder 405 and findee 410 have confirmed their relationship, the finder 405 and findee 410 may perform a more accurate location operation, e.g., a UWB ranging operation. Thus, the BT advertisement 465 may also include information indicating that the finder 405 may start the ranging operation to determine a more accurate location of the findee.

In 470, the BT controller 408 may send the information included in the BT advertisement 465 to the client/system 406, which may then, in 475, perform the ranging operation with the findee to determine the more accurate location of the findee 410. Similarly, in 480, the findee 410 may also perform the ranging operation with the finder 405. The ranging operation is outside the scope of the present example embodiments is not described further herein.

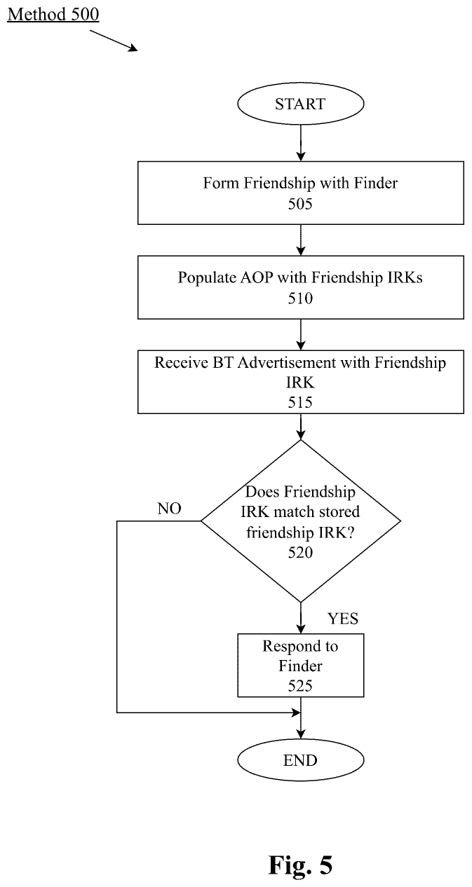

FIG. 5 shows an example method 500 for performing a find location operation according to various example embodiments. The method 500 is described from the viewpoint of the findee, e.g., the wireless communication device 120 in the above examples.

In 505, the wireless communication device 120 forms friendships with other wireless communication devices that are allowed to find the wireless communication device 120, e.g., generates a friendship IRK with the wireless communication device 110.

In 510, the wireless communication device 120 populates its AOP with the friendship IRKs. As described above, in some examples, the BT firmware stores a table that includes entries for all wireless communication devices with which the wireless communication device 120 has formed friendships and the BT controller may populate the AOP with this information.

In 515, the wireless communication device 120 receives a BT advertisement that includes information indicating that the wireless communication device transmitting the BT advertisement is attempting to perform a find location operation with another wireless communication device, e.g., by including a friendship IRK in the BT advertisement.

In 520, the wireless communication device 120 determines if the BT advertisement was meant for the wireless communication device 120, e.g., the AOP of the wireless communication device 120 compares the friendship IRK in the BT advertisement to the stored friendship IRKs.

If there is no match, the method 500 ends (at least with respect to this BT advertisement) because the BT advertisement was not destined for the wireless communication device 120. The wireless communication device 120 may continue to scan for additional advertisements and perform the operation 520 for these additional advertisements.

If there is a match, in 525, the wireless communication device 120 may respond to the wireless communication device that transmitted the BT advertisement. The response may include transmitting a BT advertisement that may be received by the other wireless communication device. As was described above, the match may also cause certain operations to be performed by the wireless communication device 120, e.g., waking up an application or baseband processor. In addition, the successful find location operation may lead to the wireless communication device 120 and the other wireless communication device performing a ranging operation to allow the other wireless communication device to obtain a more accurate location of the wireless communication device 120.

### Examples

In a first example, a method, comprising receiving an indication of a second wireless communication device allowed to perform find location operations with the first wireless communication device, wherein the indication comprises a first identity resolving key (IRK) that is unique to the second wireless communication device, receiving a payload of an advertisement comprising an IRK and comparing the IRK to the first IRK received by the always on processor.

In a second example, the method of the first example, further comprising ignoring the advertisement when the IRK does not match the first IRK.

In a third example, the method of the first example, further comprising sending, when the IRK matches the first IRK, a message to an application processor of the first wireless communication device indicating the second wireless communication device has been identified in a find location operation.

In a fourth example, the method of the first example, further comprising receiving the first IRK from a Bluetooth controller of the first wireless communication device.

In a fifth example, the method of the fourth example, wherein the payload of the advertisement is received from the Bluetooth controller.

In a sixth example, the method of the first example, wherein the payload of the advertisement is encrypted based on a Bluetooth address of a wireless communication device transmitting the advertisement and the IRK.

In a seventh example, the method of the sixth example, further comprising decrypting the payload using the first IRK and a Bluetooth address of the second wireless communication device.

In an eighth example, the method of the seventh example, wherein the payload of the advertisement is encrypted using a SipHash function.

In a ninth example, an always-on processor configured to perform any of the methods of the first through eighth examples.

In a tenth example, a wireless communication device configured to perform any of the methods of the first through eighth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
process an indication of a wireless communication device with which the apparatus is allowed to perform find location operations, wherein the indication comprises a first identity resolving key (IRK) that is unique to the wireless communication device;
process a payload of an advertisement comprising an IRK; and
compare the IRK to the first IRK received by the always on processor.

2. The apparatus of claim 1, wherein the processing circuitry is further configured to:
ignore the advertisement when the IRK does not match the first IRK.

3. The apparatus of claim 1, wherein the processing circuitry is further configured to:
send, when the IRK matches the first IRK, a message to an application processor indicating the wireless communication device has been identified in a find location operation.

4. The apparatus of claim 1, wherein the processing circuitry is further configured to:
process, based on signaling received from a Bluetooth controller, the first IRK.

5. The apparatus of claim 4, wherein the payload of the advertisement is received from the Bluetooth controller.

6. The apparatus of claim 1, wherein the payload of the advertisement is encrypted based on a Bluetooth address of a device transmitting the advertisement and the IRK.

7. The apparatus of claim 6, wherein the processing circuitry is further configured to:
decrypt the payload using the first IRK and a Bluetooth address of the wireless communication device.

8. The apparatus of claim 6, wherein the payload of the advertisement is encrypted using a SipHash function.

9. The apparatus of claim 1, wherein the processing circuitry comprises an always on processor.

10. A method, comprising:
receiving an indication of a wireless communication device with which find location operations are allowed to be performed, wherein the indication comprises a first identity resolving key (IRK) that is unique to the wireless communication device;
receiving a payload of an advertisement comprising an IRK; and
comparing the IRK to the first IRK.

11. The method of claim 10, further comprising:
ignoring the advertisement when the IRK does not match the first IRK.

12. The method of claim 10, further comprising:
sending, when the IRK matches the first IRK, a message to an application processor indicating the wireless communication device has been identified in a find location operation.

13. The method of claim 10, further comprising:
receiving the first IRK from a Bluetooth controller.

14. The method of claim 13, wherein the payload of the advertisement is received from the Bluetooth controller.

15. The method of claim 10, wherein the payload of the advertisement is encrypted based on a Bluetooth address of a device transmitting the advertisement and the IRK.

16. The method of claim 15, further comprising:
decrypting the payload using the first IRK and a Bluetooth address of the wireless communication device.

17. The method of claim 16, wherein the payload of the advertisement is encrypted using a SipHash function.

18. The method of claim 10, wherein the method is performed by an always on processor.

19. A first wireless communication device, comprising:
a transceiver configured to communicate with a second wireless communication device; and
an always on processor configured to:
process an indication of the second wireless communication device allowed to perform find location operations with the first wireless communication device, wherein the indication comprises a first identity resolving key (IRK) that is unique to the second wireless communication device;
process a payload of an advertisement comprising an IRK; and
compare the IRK to the first IRK received by the always on processor.

20. The first wireless communication device of claim 19, wherein the always on processor is further configured to:
ignore the advertisement when the IRK does not match the first IRK; and
send, when the IRK matches the first IRK, a message to an application processor of the first wireless communication device indicating the second wireless communication device has been identified in a find location operation.
